(19) United States
(12) Patent Application Publication
(10) Pub. No.: US 2016/0240335 A1
(43) Pub. Date: Aug. 18, 2016

(54) CIRCUIT BREAKER CROSSBAR ASSEMBLY AND METHOD

(71) Applicant: General Electric Company, Schenectady, NY (US)

(72) Inventors: George Michael CHELEDNIK, Plainville, CT (US); Wolfgang MEYER-HAACK, West Hartford, CT (US); Katherine Marjorie COUGHLIN, West Hartford, CT (US); Andrew Matthew CANDELORA, East Haven, CT (US)

(21) Appl. No.: 15/042,198

(22) Filed: Feb. 12, 2016

Related U.S. Application Data
(60) Provisional application No. 62/117,191, filed on Feb. 17, 2015.

(51) Int. Cl. H01H 21/22

(52) U.S. Cl. CPC H01H 21/22; H01H 2235/01

(57) ABSTRACT

A circuit breaker crossbar assembly is provided and includes a crossbar rotatable between a first rotational position and a second rotational position, the crossbar is coupleable to at least one moveable contact arm of the circuit breaker. The circuit breaker crossbar assembly also includes an insert member disposed in communication with the crossbar and the at least one moveable contact arm to thereby exert a force on the at least one moveable contact arm.

### BACKGROUND OF THE INVENTION

The subject matter disclosed herein relates to circuit breakers and, more particularly to a circuit breaker crossbar assembly.

Multi-phase industrial electrical power distribution systems are protected against damage from overcurrent circuit conditions by corresponding single or multi-pole circuit breakers wherein each phase of the power distribution circuit is directed through a separate pole within the circuit breaker assembly. The overcurrent situations may be caused, for example, by short circuits or ground faults in or near such equipment. A circuit breaker may be manually switched from an “ON” condition to an “OFF” condition and vice versa. Additionally, the circuit breaker typically includes a mechanism that is configured to automatically switch the circuit breaker to an “OFF” (e.g., “TRIP”) condition in response to an undesirable operating situation, such as a short circuit, for example.

Circuit breakers typically include at least one pair of separable main contacts housed within a housing which typically comprises a base and a corresponding cover. The separable contacts may be operated either manually by way of an operating handle disposed on the outside of the circuit breaker housing and in operative communication with an operating mechanism disposed within the circuit breaker housing, or automatically in response to an overcurrent condition. In the automatic mode of operation, the contacts may be opened by an operating mechanism, controlled by a trip unit, or by magnetic repulsion forces generated between the stationary and movable contacts during relatively high levels of over current. Because of the potential for damage caused by the overcurrent conditions, it is desirable to trip the circuit breaker as rapidly as possible to interrupt the current flow through the circuit breaker.

Typically, the at least one pair of separable main contacts comprise a moveable contact and a stationary contact, wherein the moveable contact is selectively moved by the operating mechanism between the ON condition in contact with the stationary contact, and the OFF position separate from the stationary contact, and vice versa. The circuit breaker operating mechanism often includes a crossbar unit that is operatively coupled to the movable contact and arranged to rotate or otherwise move the moveable contacts between the ON and OFF conditions.

Various components are employed to convert the manual input or the automatic initiation of condition switching to rotation of moveable contact arm assemblies that determine a condition of the circuit breaker. Conventionally, the circuit breaker is in an “ON” or closed condition when one or more moveable contacts coupled to corresponding moveable contact arms are engaged with a respective stationary contact. Conversely, the circuit breaker is in an open, OFF or TRIP condition when the one or more moveable contacts are disengaged from the respective stationary contact. One conventional component that may rotate the moveable contact arm assemblies is a common crossbar that is rotatably coupled to the moveable contact arm assemblies.

Different circuit breakers require moveable contact arm assemblies that are of distinct configurations. For example, the moveable contact arm assemblies will vary in size and shape, to provide desired performance characteristics, or to obtain a desired rating for a circuit breaker. Based on the various geometries of the moveable contact arm assemblies in circuit breakers of different ratings, a custom or specifically configured crossbar is required to enable proper operation of the contact arm assembly in circuit breakers of a given rating. This requires manufacturing different crossbars, corresponding to specific contact arm assemblies and circuit breaker ratings, thereby adding time, cost and complexity to the manufacturing process. It would be desirable to provide a circuit breaker capable of using a standard crossbar that is configured to perform across a range of circuit breaker ratings, and with a variety of moveable contact arm assemblies.

### BRIEF DESCRIPTION OF THE INVENTION

According to one aspect of the invention, a circuit breaker crossbar assembly is provided and includes a crossbar rotatable between a first rotational position and a second rotational position, the crossbar operably coupleable to at least one moveable contact arm of the circuit breaker. The circuit breaker crossbar assembly also includes an insert member disposed in communication with the crossbar and the at least one moveable contact arm assembly to exert a force on the at least one moveable contact arm.

According to another aspect of the invention, a circuit breaker is provided and includes a plurality of moveable contact arm assemblies configured to conduct current through the circuit breaker. Also included is a crossbar operatively coupled to the plurality of moveable contact arm assemblies, rotatable between a first rotational position and a second rotational position. Further included a mechanism configured to selectively rotate the crossbar between the first and second rotational positions. Yet further included is a plurality of insert members, each of the plurality of insert members coupled there between the crossbar and a respective moveable contact arm assembly, and arranged to exert a force on the respective moveable contact arm assembly.

According to yet another aspect of the invention, a method of assembling a crossbar assembly for a circuit breaker is provided. The method includes operably coupling a portion of a moveable contact arm assembly to a crossbar, the moveable contact arm assembly selected from a plurality of distinct configurations of moveable contact arm assemblies. The method also includes manufacturing an insert member having a customized configuration that is determined by a configuration of the moveable contact arm assembly operably coupled to the crossbar. The method further includes disposing the insert member between, and into communication with, the crossbar and the moveable contact arm assembly to exert a force on the moveable contact arm.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a mechanism assembly and a crossbar assembly of a circuit breaker;

FIG. 2 is a perspective disassembled view of a crossbar and insert member of the circuit breaker;

FIG. 3 is a perspective assembled view of the crossbar coupled to a plurality of moveable contact arm assemblies and the insert member;

FIG. 4 is a perspective, sectional view of the crossbar assembly having an insert member according to a first embodiment to accommodate a first configuration of a moveable contact arm; and

FIG. 5 is a perspective, sectional view of the crossbar assembly having an insert member according to a second embodiment to accommodate a second configuration of a moveable contact arm.

The detailed description explains embodiments of the invention, together with advantages and features, by way of example with reference to the drawings.

### DETAILED DESCRIPTION OF THE INVENTION

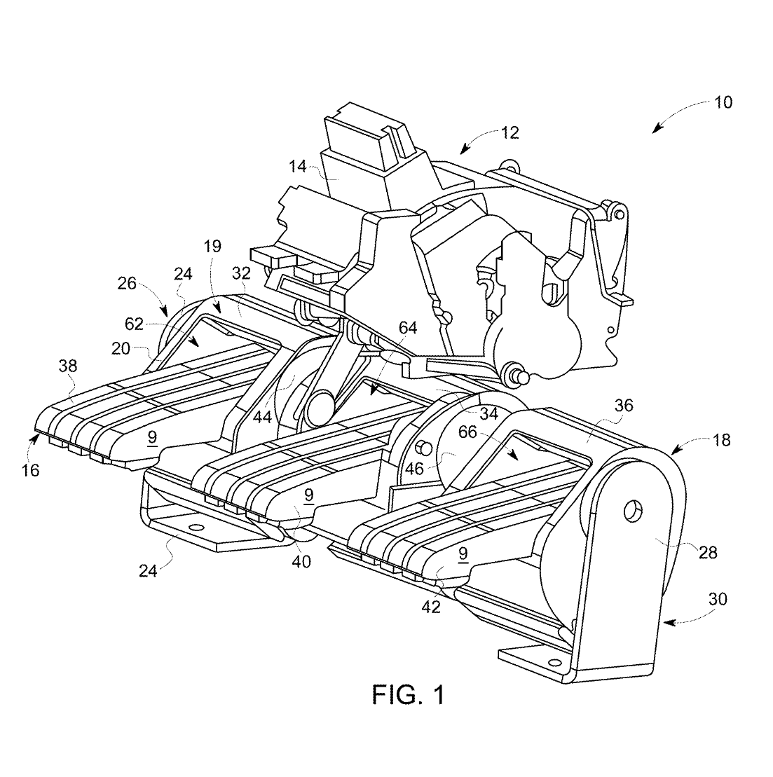

Referring to FIG. 1, a circuit breaker 10 of the multi-pole variety is partially illustrated. The circuit breaker 10 has a cover and housing removed to better illustrate various components of the circuit breaker 10 that are relevant to the embodiments of the invention described herein. The circuit breaker 10 includes a mechanism 12 that is generally referenced with numeral 12. The mechanism 12 is configured to enable a selective switching of the circuit breaker 10 between an open and a closed state. For example, the mechanism 12 may include a number of components configured to detect a hazardous or undesirable operating condition and to initiate switching the circuit breaker 12 from a closed condition, to a tripped or open condition. Additionally, manual manipulation of the condition of the circuit breaker mechanism 12 may be selectively facilitated with a handle 14 that may be actuated by an operator. This gives the operator the ability to turn the circuit breaker 10 “ON” to energize a protected circuit, turn the circuit breaker “OFF” to disconnect the protected circuit, or reset the circuit breaker 10 from a tripped condition. Overall, the mechanism 12 converts movement of the handle 14 into mechanical force to operate the circuit breaker 10.

The circuit breaker 10 illustrated depicts a three-phase configuration, however, the embodiments disclosed herein are not limited to this configuration, such that alternative phase configurations (e.g., one-phase, two-phase, four-phase, etc.) may be employed. Specifically, three moveable contact arm assemblies 16 are illustrated. For example, in the depicted embodiment, each of the moveable contact assemblies 16 may be associated with a corresponding phase of a protected circuit. The moveable contact arm assemblies 16 may comprise one or more conductive individual moveable contact arms 9. The moveable contact arm assemblies 16 are coupled to the crossbar 19 and are selectively rotatable in response to rotation of the crossbar 19. In an embodiment, the moveable contact arms 9 may be disposed, at least partially, within a crossbar assembly 18 that includes a crossbar 19. The crossbar 19 extends from a first end 20 to a second end 22. The first end 20 of the crossbar 19 is operatively rotatably coupled to a first bracket 24 disposed on a first side 26 of the circuit breaker 10. Similarly, the second end 22 of the crossbar 19 is operatively rotatably coupled to a second bracket 28 located on a second side 30 of the circuit breaker 10. The coupling of the crossbar to the respective first and second brackets 24, 28 may be made with any suitable coupling that allows selective rotation of the crossbar 19, such as with pin joint connections.

In operation, the crossbar 19 rotates upon actuation from the mechanism 12 to selectively drive the moveable contact arm assemblies 16 into a position that either renders the circuit breaker 10 in the “ON” condition, the “OFF” condition, or the “TRIP” condition. Specifically, in the event an operator manually operates mechanism 12 turns the circuit breaker 10 toward the ON condition, the mechanism 12 interacts with the crossbar 19, which in turn drives the moveable contact arm assemblies 16 toward a closed position. In the event an operator manually actuates the mechanism 12 to switch the circuit breaker 10 from an ON condition toward an OFF condition, or in the alternative, if the mechanism automatically initiates a tripping sequence, the mechanism 12 interacts with the crossbar 19, causing it to rotate, which in turn rotates the moveable contact arm assemblies 16 toward an open position.

In an embodiment, the crossbar 19 includes multiple segments that are operatively coupled to the moveable contact arm assemblies 16. In the illustrated embodiment with three moveable contact arm assemblies, a first segment 32, a second segment 34 and a third segment 36 are included to correspond to the number of moveable contact arm assemblies. In such an embodiment, the first segment 32 is associated with a first moveable contact arm assembly 38, the second segment 34 is associated with a second moveable contact arm assembly 40, and the third segment 36 is associated with a third moveable contact arm assembly 42. Disposed between each pair of segments is at least one coupling segment of the crossbar 19. In the illustrated embodiment, a first coupling segment 44 is disposed between the first segment 32 and the second segment 34 of the crossbar 19, and therefore between the first moveable contact arm assembly 38 and the second moveable contact arm assembly 40. Similarly, a second coupling segment 46 is disposed between the second segment 34 and the third segment 36 of the crossbar 19, and therefore between the second moveable contact arm assembly 40 and the third moveable contact arm assembly 42. As noted above, the number of segments and moveable contact arm assemblies may vary depending upon the particular circuit breaker, and as a result it is to be appreciated that the number of associated coupling segments may vary as well.

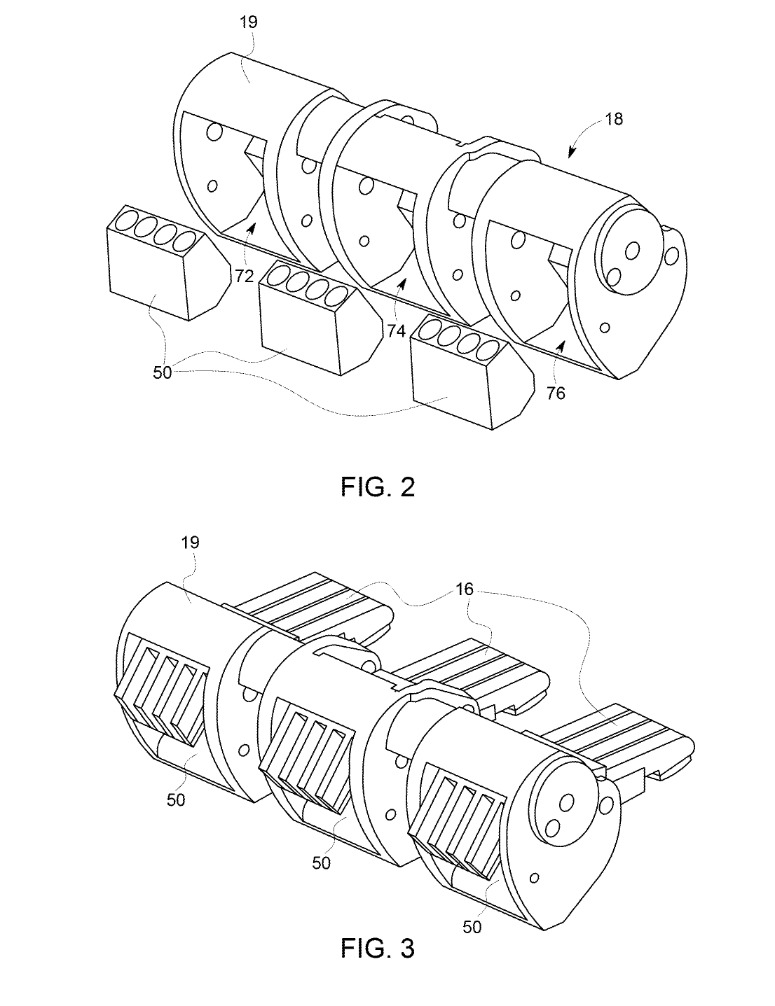

Referring now to FIGS. 2 and 3, the crossbar assembly 18 is illustrated in greater detail. FIG. 2 depicts the crossbar assembly 18 in a disassembled condition. In particular, the crossbar 19 is shown without the moveable contact arm assemblies 16 operatively coupled thereto. Additionally, a plurality of insert members 50 are shown in a pre-assembly condition. As will be appreciated from the description herein, the insert members 50 are customizable components that are manufactured to have an overall configuration, including size and shape, that is dependent upon the particular configuration of the moveable contact arm assemblies 16. This is advantageous based on the need for distinct moveable contact arm assembly configurations and quantities in different types of circuit breakers. Rather than requiring a unique crossbar for each type of moveable contact arm, use of the insert members 50 facilitate the manufacture of a single standard crossbar that is well-suited to accommodate multiple configurations of moveable contact arm assemblies. For example, it may be less costly for a manufacturer of circuit breakers to provide a line a circuit breakers having several models or frames, each model or frame having a different current rating associated with different moveable contact arm assembly 16, by using a common or standard crossbar 19, in conjunction with a less costly customized insert member 50, rather than using a customized crossbar for each rating without an insert member as in the prior art.. The insert members 50 may be formed of any suitable manufacturing process. In one embodiment, the insert members 50 are molded components. Alternatively, the insert members 50 may be formed by a machining process.

As shown in FIG. 3, the insert members 50 are disposed between, and coupled to, the crossbar 19 and the moveable contact arm assemblies 16. Specifically, each insert member 50 is sandwiched between the crossbar 19 and a corresponding moveable contact arm 16. As discussed above, the insert member 50 is sized and shaped in a customizable manner that is dependent upon the configuration of the moveable contact arm assemblies. In this way, a common or standard crossbar is able to function with a variety of moveable contact arm assemblies in cooperation with a customized insert member 50.

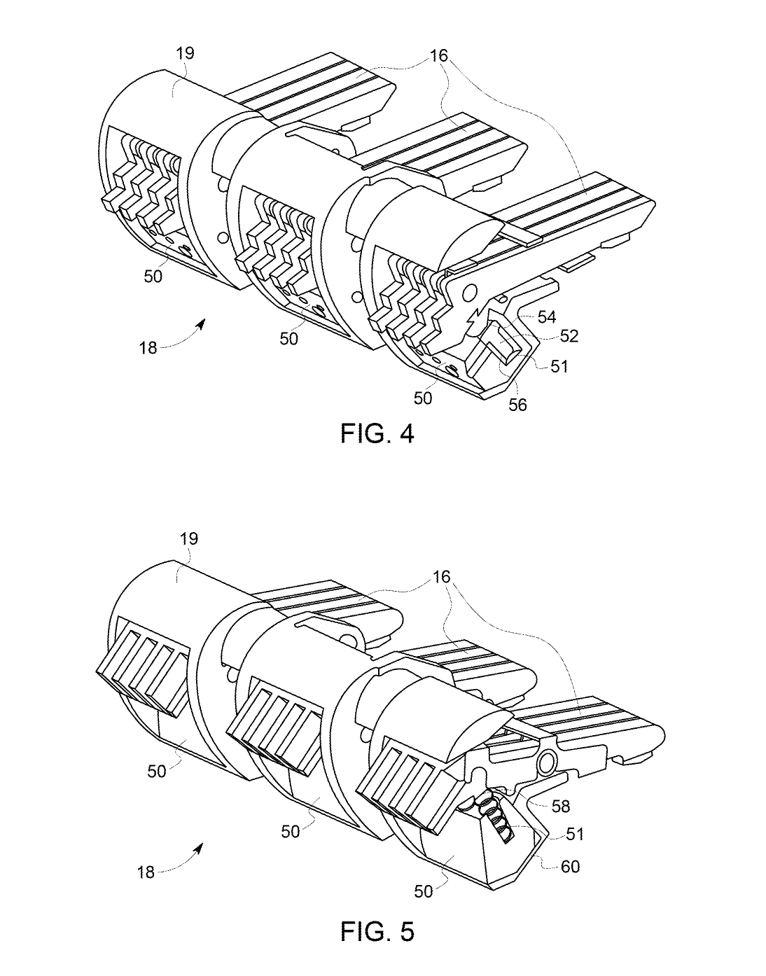

Referring to FIG. 4, the insert member 50 is illustrated according to a first embodiment. To facilitate a better understanding of the insert member 50, a portion of the crossbar assembly 18 has been cut-away to better illustrate features of the insert member 50. As described above, the insert member 50 is disposed between the crossbar 19 and a corresponding moveable contact arm assembly 16 in a sandwiched manner. For example, in an embodiment, each of the crossbar segments 32, 34, 36 defines a respective aperture 62, 64, 66 defined thereon. The aperture 62, 64, 66 is sized and disposed to operatively receive a respective moveable contact arm assembly 16 there through. In an embodiment, each of the crossbar segments 32, 34, 36 may further define a cavity 72, 74, 76 therein. Each cavity 72, 74, 76 extends to the corresponding aperture 62, 64, 66 and is sized and arranged to receive the corresponding insert member 50 therein. Further, each cavity 72, 74, 76 is sized to operatively receive a corresponding insert member therein.

It is contemplated that one or more components are disposed between the insert member 50 and the crossbar 19 and/or the moveable contact arm assemblies 16, such that the insert member 50 may be coupled in indirect contact with the components. The insert member 50 may simply be sandwiched in the space between the crossbar 19 and the moveable contact arm assembly 16, as described above, or may be mechanically fastened thereto with one or more mechanical fasteners, such as pins or threaded fasteners, for example.

In the fully assembled condition, the insert member 50 is configured to exert a force on the moveable contact arm assembly to ensure that an appropriate connection is made between the moveable contact arm assembly and a fixed contact (not shown) to complete a circuit, when desired. In an embodiment, the force is facilitated by a biasing member 51. In various embodiments, the biasing member may be integrally formed with, or operatively coupled to, the insert member 50. In the illustrated embodiment of FIG. 4, the insert member includes a plunger 52 that is coupled to the moveable contact arm assembly 16 at a first end 54 of the plunger 52. In the illustrated embodiment, the biasing member 51 coupled in mechanical communication with the plunger 52 at a second end 56 of the plunger and comprises any suitable resilient element configured to bias the plunger 52 in order to exert the force on the moveable contact 16 arm.

Referring to FIG. 5, the insert member 50 is illustrated according to a second embodiment. As with the embodiment of FIG. 4, to facilitate a better understanding of the insert member 50, a portion of the crossbar assembly 18 has been cut-away to better illustrate features of the insert member 50. The insert member 50 is situated between the crossbar 19 and the moveable contact arm assemblies 16 in a manner similar to the insert member described above in conjunction with FIG. 4, however, the biasing member 51 differs in this embodiment. In the illustrated embodiment, the biasing member 51 comprises a spring that is operatively coupled to the moveable contact arm assembly 16 at a first end 58 of the spring and operatively coupled to the insert member 50 at a second end 60 of the spring, thereby exerting the biasing force on the moveable contact arm assembly 16.

Advantageously, a single configuration of a crossbar 19 may be utilized with distinct types of moveable contact arm assemblies 16 with the use of the insert members 50 described herein. This beneficially reduces or eliminates the need for manufacture of distinct configurations of crossbars to match unique types of moveable contact arm assemblies, thereby reducing manufacturing time, cost and complexity. The insert members 50 are much less expensive and easier to manufacture on a customizable basis, when compared to the larger and more complex crossbars.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A circuit breaker crossbar assembly comprising:
a crossbar rotatable between a first rotational position and a second rotational position, the crossbar coupled to at least one moveable contact arm of the circuit breaker; and
an insert member disposed in communication with the crossbar and the at least one moveable contact arm operative to exert a force on the at least one moveable contact arm.

2. The circuit breaker crossbar assembly of claim 1, further comprising a biasing member coupled to the insert member and arranged to exert the force on the at least one moveable contact arm.

3. The circuit breaker crossbar assembly of claim 2, wherein the biasing member comprises a spring operatively coupled to the insert member at a first end of the spring and to the at least one moveable contact arm at a second end of the spring.

4. The circuit breaker crossbar assembly of claim 2, wherein the insert member includes a plunger operatively coupled to the at least one moveable contact arm at a first end of the plunger and operatively coupled to the biasing member at a second end of the plunger.

5. The circuit breaker crossbar assembly of claim 1, wherein the crossbar defines a cavity therein, and an aperture thereon, the cavity extending to the aperture, wherein a portion of the at least one moveable contact arm is operatively received there through the aperture and disposed in the cavity.

6. The circuit breaker crossbar assembly of claim 5, wherein the insert member is a molded component with a configuration dependent upon the configuration of the at least one moveable contact arm.

7. The circuit breaker crossbar assembly of claim 1, wherein the crossbar is operably coupleable to a plurality of moveable contact arm assemblies of the circuit breaker.

8. The circuit breaker crossbar assembly of claim 7, further comprising a plurality of insert members, each of the plurality of insert members operatively coupled to a respective one of the plurality of moveable contact arm assemblies.

9. A circuit breaker comprising:
a plurality of moveable contact arm assemblies configured to conduct current through the circuit breaker;
a crossbar operatively coupled to the plurality of moveable contact arm assemblies, rotatable between a first rotational position and a second rotational position;
a mechanism configured to selectively rotate the crossbar between the first and second rotational positions;
and
a plurality of insert members, each of the plurality of insert members coupled there between the crossbar and a respective moveable contact arm assembly, and arranged to exert a force on the respective moveable contact arm assembly.

10. The circuit breaker of claim 9, wherein each of the plurality of insert members is a molded component with a configuration dependent upon the configuration of the respective moveable contact arm assembly.

11. The circuit breaker of claim 9, further comprising a biasing member disposed there between a corresponding insert member and moveable contact arm assembly, and arranged to exert the force on the respective moveable contact arm assembly.

12. The circuit breaker of claim 11, wherein the biasing member comprises a spring coupled to one of the plurality of insert members at a first end of the spring and coupled to the respective moveable contact arm assembly at a second end of the spring.

13. The circuit breaker of claim 11, wherein each of the plurality of insert members includes a plunger coupled there between the respective moveable contact arm assembly at a first end of the plunger and the corresponding biasing member at a second end of the plunger.

14. A method of assembling a crossbar assembly for a circuit breaker comprising:
coupling a portion of a moveable contact arm assembly to a crossbar, the moveable contact arm assembly selected from a plurality of distinct configurations of moveable contact arm assemblies;
manufacturing an insert member having a customized configuration that is determined by a configuration of the moveable contact arm assembly coupled to the crossbar; and
disposing an insert member between, and into communication with, the crossbar and the moveable contact arm assembly to thereby exert a force on the moveable contact arm.

15. The method of claim 14, further comprising coupling a biasing member there between the moveable contact arm assembly and the insert member to thereby exert the force on the moveable contact arm.

16. The method of claim 15, wherein the biasing member comprises a spring having a first end and a second end; further comprising operatively coupling the spring to the moveable contact arm assembly at the first end and to the insert member at the second end.

17. The method of claim 15, further comprising biasing the moveable contact arm assembly by disposing a plunger in contact with the moveable contact arm assembly at a first end of the plunger with the biasing member in contact with the plunger at a second end of the plunger.
